(19) United States
(12) Patent Application Publication
(10) Pub. No.: US 2008/0217117 A1
(43) Pub. Date: Sep. 11, 2008

(54) Disc Brake and an Additional Brake Actuator Therefore

(76) Inventors: Lars Severinsson, Hishult (SE); Goran Stensson, Brosarp (SE)

Correspondence Address: ST. ONGE STEWARD JOHNSTON & REENS, LLC, 986 BEDFORD STREET, STAMFORD, CT, 06905-5619, US

(21) Appl. No.: 12/041,183

(22) Filed: Mar. 3, 2008

(30) Foreign Application Priority Data
Mar. 5, 2007 (SE) 0700525-9

(51) Int. Cl. F16D 65/34; F16D 55/224

(52) U.S. Cl. 188/72.1; 188/156

(57) ABSTRACT

A disc brake comprises a disc brake caliper, which includes a brake application mechanism with an input element, and a service brake actuator providing a brake application force to the input element via a push rod. An electromechanical brake actuator is arranged between the caliper and the service brake actuator and applies its force at will on the push rod.

### CROSS-REFERENCE TO RELATED APPLICATIONS

The present application claims priority of Swedish patent application No. 0700525-9 filed on Mar. 5, 2007, the content of which is incorporated herein by reference.

### FIELD OF THE INVENTION

The present invention relates to a disc brake, comprising a disc brake caliper, which includes a brake application mechanism with an input element, and a service brake actuator providing a brake application force to the input element via a push rod. It also relates to an additional brake actuator therefore.

### BACKGROUND OF THE INVENTION

A disc brake of the above defined kind is today commonly used on trucks, buses and trailers, but other uses are also feasible. Primarily for obtaining a parking brake function or park-lock function for such a disc brake, an additional brake actuator, below often called a parking brake actuator for convenience, can be added. Many different requirements have to be fulfilled for such a parking brake actuator, and many designs are previously known. However, no known design has been able to fulfill all requirements.

### SUMMARY OF THE INVENTION

The main object of the invention is to solve many of the problems inherent in previously known attempts in providing a parking brake function or park-lock function for a disc brake of the kind defined.

This is according to the invention accomplished by an electromechanical brake actuator arranged between the caliper and the service brake actuator and applying its force at will on the push rod.

Compressed air is conventionally used on heavy road vehicles for service braking and for certain other functions. (The service brake actuator used in the disc brake according to the invention may, however, equally well be hydraulically or electrically actuated.) Electricity is increasingly being used for certain other functions on such vehicles. For various reasons, it may be suitable to use different media for service braking and parking braking. For the parking brake actuator according to the invention, an electric motor is preferably used for its application.

The electromechanical actuator is primarily used for parking brake application, but it can also be used for service brake application, either together with the service brake actuator or on its own (in emergency cases).

The electromechanical actuator can also be used for park lock, i e then it has an actuating retaining function only.

It is generally of advantage, if systems can be designed in modularized form. According to the invention, the parking brake actuator can therefore be designed as a module optionally to be inserted between the service brake actuator and the disc brake caliper. As the space available in the vehicle chassis often is very limited, the outer dimensions of the module shall be kept at a minimum.

Due to the pivotal movement of the lever in the disc brake caliper during brake application, the push rod from the service brake actuator will have not only an axial movement but also a certain radial or pendulumlike movement. This movement will be allowed in a parking brake actuator according to the invention.

A parking brake actuator of the above kind may according to the invention practically be characterized by a drive sleeve rotatably journaled in a housing of the parking brake actuator and an electric motor for rotation of the drive sleeve, a drive socket, through which the push rod extends, and means for transforming the rotational movement of the drive sleeve into an axial movement of the push rod through the participation of the drive socket.

In order to obtain the modular design, the push rod of the parking brake actuator may be slidably mounted as a prolongation of a piston rod of the service brake actuator.

In a first embodiment of the actuator according to the invention, the drive socket has external grooves or an external thread for engagement with an internal thread in the drive sleeve, means being provided for preventing rotation of the drive socket, and the push rod is provided with a flange, with which the drive socket may engage.

Used as a normal parking brake actuator, the device has to have a low internal friction. This is obtained in that the drive socket has rotatable rollers provided with grooves.

The actuator may, however, also be used for obtaining a park-lock function. Here, the brake is applied by the service brake actuator, and the actuator is only used to lock the brake in the applied condition. In this case the internal friction is of less importance, and a cheaper and simpler design in which the drive socket has an external thread can be used.

In the first embodiment, referred to above, the means for preventing rotation of the drive socket may be fingers on an insert in the housing, the fingers extending in between the rollers.

In a second embodiment of the actuator according to invention, the drive socket has internal grooves or an internal thread for engagement with an external thread on the push rod, means being provided for rotatably connecting the drive socket with the drive sleeve. Hereby, an actuator with a decreased axial length may be obtained, which may be of importance in many instances.

At normal parking braking the drive socket preferably has rotatable rollers provided with grooves.

In a simplified version for park-lock use the drive socket itself can have an internal thread.

In the second embodiment the means for rotatably connecting the drive socket with the drive sleeve may be fingers on an insert in the drive sleeve, the fingers extending in between the rollers.

It is well known in the art that difficulties with the parking brake function may occur, when the brake disc cools off and shrinks somewhat. In order to ensure that the parking brake will be safely applied, even when the brake disc cools off, a pre-tensioned compression spring may be arranged between the housing and a thrust bearing for the drive sleeve or between the drive sleeve and the thrust bearing.

An arrangement according to the invention has many advantages:

The brake layout is modularized, so that wheels not needing a parking brake or an additional actuator may have the same components as other wheels except the electromechanical actuator.

Electric actuation reduces the need for piping and valves related to commonly used spring-based pneumatic actuators and makes it possible to reduce weight, cost and required installation space.

The electromechanical actuator may have smaller overall dimensions than a spring-based pneumatic actuator.

By mounting the electromechanical actuator between the service brake actuator and the caliper, there is no need for extra holes or modifications, which is the case at the mounting of a parking brake actuator on the back of the service brake actuator.

The parking brake actuator according to the invention allows for an arc-shaped movement of the push rod from the service brake actuator, which further facilitates a combination with current designs of service brake actuators and brake application mechanisms with a minimum of modifications.

The proposed actuators can be used as park-lock devices only, in which case the actuator design can be simplified and minimized.

### BRIEF DESCRIPTION OF THE DRAWINGS

The invention will be described in further detail below under reference to the accompanying drawings, in which:

FIG. 1 is an isometric view of an additional brake actuator according to the invention incorporated as a module in a conventional disc brake,

FIG. 2 is a view of members of a first embodiment of the additional brake actuator with portions broken away for illustrative purposes,

FIG. 3 is a sectional view through a disc brake with the additional brake actuator according to FIG. 2 in an inactive or non-applied position,

FIG. 4 corresponds to FIG. 3 but shows the additional brake actuator in an active or applied position,

FIG. 5 is a view generally corresponding to FIG. 2 of a modified additional brake actuator according to the invention,

FIG. 6 is a view also generally corresponding to FIG. 2 but with the modification of FIG. 5 and with a certain simplification for park-lock purposes,

FIG. 7 is a sectional view corresponding to FIG. 3 of a second embodiment of an additional brake actuator according to the invention,

FIG. 8 is a view generally corresponding to FIG. 2 (although portions are broken away) of the second embodiment, and

FIG. 9 is a sectional view of an additional brake actuator, being a modification of the actuator according to FIG. 3.

### DETAILED DESCRIPTION OF THE INVENTION

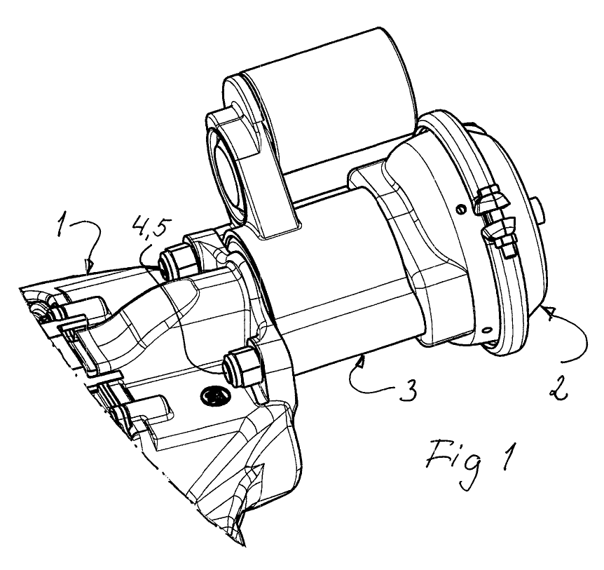

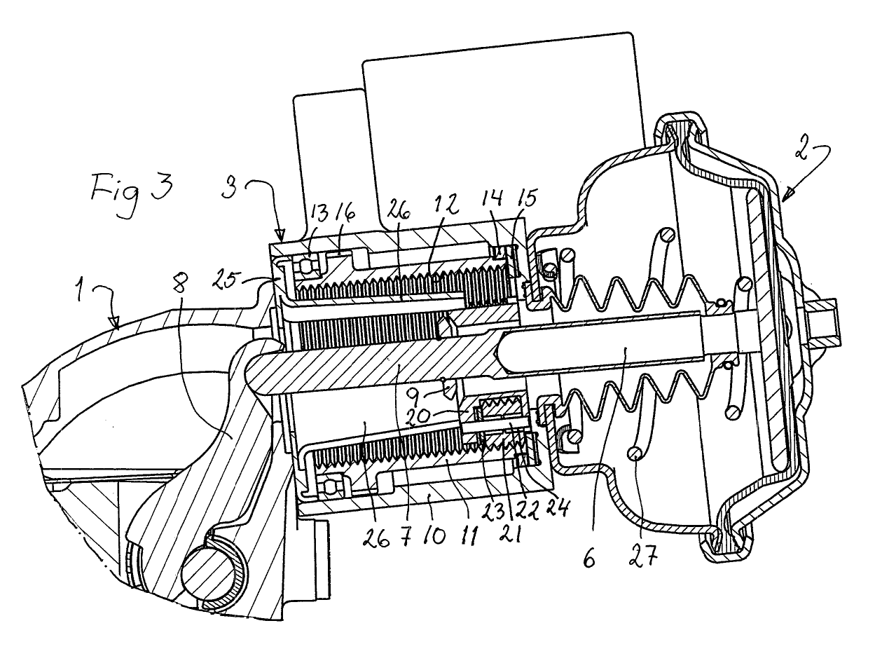

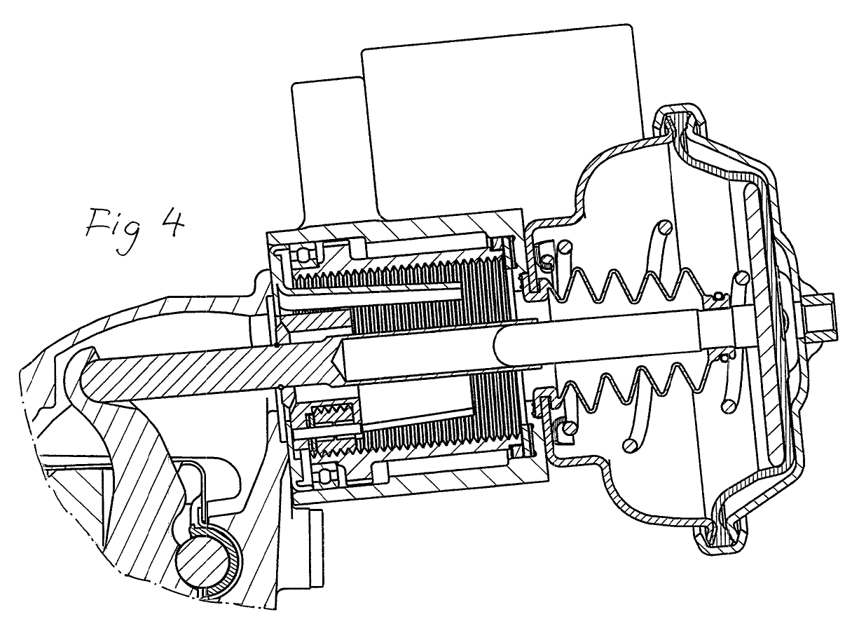

FIG. 1 illustrates a conventional disc brake caliper 1 with a service brake actuator 2. To the extent necessary for the proper understanding of the invention, an example of a caliper 1 and a service brake actuator 2 are further shown in FIGS. 3 and 4. The arrangement is primarily intended for use on heavy road vehicles, such as trucks, trailers, and buses, but other uses are feasible.

The caliper—for a so-called spot type disc brake—can be of the fixed or sliding type and can be used together with one or more brake discs arranged axially sliding or not sliding.

The service brake actuator 2 is shown to be pneumatically actuated, but may equally well be hydraulically or electrically actuated.

An additional electromechanical or electrically actuated brake actuator or module 3 according to the invention is mounted between the disc brake caliper 1 and the service brake actuator 2. The module 3 can primarily be used either for normal parking braking or as a park-lock, as will appear below. However, it can also be used as a supplement to or as an alternative to the service brake actuator. The term “parking brake actuator” is used below in the description for convenience.

The module 3 with through bores can be attached to the caliper 1 by the same screws 4 as the service brake actuator 2. If these screws 4 are too short, sockets 5 can be mounted thereon.

As appears from FIG. 3, there is a piston rod 6 in the service brake actuator 2. A partly sleeve-shaped push rod 7 of the parking brake module 3 is slidably mounted thereon as a prolongation thereof. Like the piston rod 6, it has a rounded end for cooperation with a pivotable amplification lever 8 in the caliper 1. The lever 8 can be defined as an input element of a brake application mechanism in the caliper 1. The push rod 7 is provided with a flange 9.

The parking brake module 3 has a housing 10, in which a drive sleeve 11 with an internal thread 12 is rotatably journaled by means of two radial bearings 13, 14 and a thrust bearing 15.

The drive sleeve 11 has an external gear 16 connected to an electric motor 17 via a motor transmission 18, 19 (in a housing common with the housing 10). As will appear, the motor transmission can be of type spur gear, worm gear or bevel gear.

A sleeve-shaped drive socket 20 is arranged around the push rod 7 inside the drive sleeve 11. Rollers 21 (in the shown case three rollers) are rotatably journaled (each on a shaft 22 with a thrust bearing 23 and a radial bearing 24) equidistantly around the drive socket 20.

Each roller 21 has external grooves (not threads) for engagement with the inner thread 12 of the drive sleeve 11; the grooves have a geometry corresponding to that of the thread 12. These grooves are axially displaced on the different rollers 21. With three equidistantly arranged rollers 21, the axial displacement will be ⅓ of the thread pitch.

The rollers 21 may be cylindrical and have axes parallel to the longitudinal symmetry axis of the actuator, but it may alternatively be advantageous to arrange the axes of the rollers 21 perpendicular to the threads, i e with a certain inclination in relation to the longitudinal axis of the actuator, in combination with a certain cambering of the rollers.

The thread engagement between the thread 12 and the rollers 21 is preferably self-locking.

An insert 25 is pressed into the end of the housing 10 (to the left in the Figures) so as to be non-rotatable. The insert 25 has fingers 26 reaching into the interspaces between the rollers 21 (and without interfering with their movability) so as to make the drive socket 20 non-rotatable.

The central opening in the drive socket 20 has a size to permit free radial movement of the push rod 7 therein at disc brake application in engagement with the caliper lever 8.

In the rest position of the parking brake module 3 shown in FIG. 3 with its drive socket 20 out of engagement with the push rod flange 9, the service brake actuator 2 with its piston rod 6 and push rod 7 will be free to operate the caliper lever 8 for service braking.

When parking braking is desired, the electric motor 17 is energized for rotating the drive sleeve 11. The rollers 21 are rolling inside the thread 12 moving the drive socket 20 forward or to the left in the Figures and hence—via the push rod flange 9—the push rod 7 in the brake application direction. The service brake piston and its piston rod 6 remain unaffected and in the unapplied position during this parking brake application.

FIG. 4 illustrates the arrangement in a fully applied parking brake condition. FIG. 4 is not provided with any reference numbers for the sake of clarity.

Parking brake release is accomplished by rotating the electric motor 17 in the reverse direction.

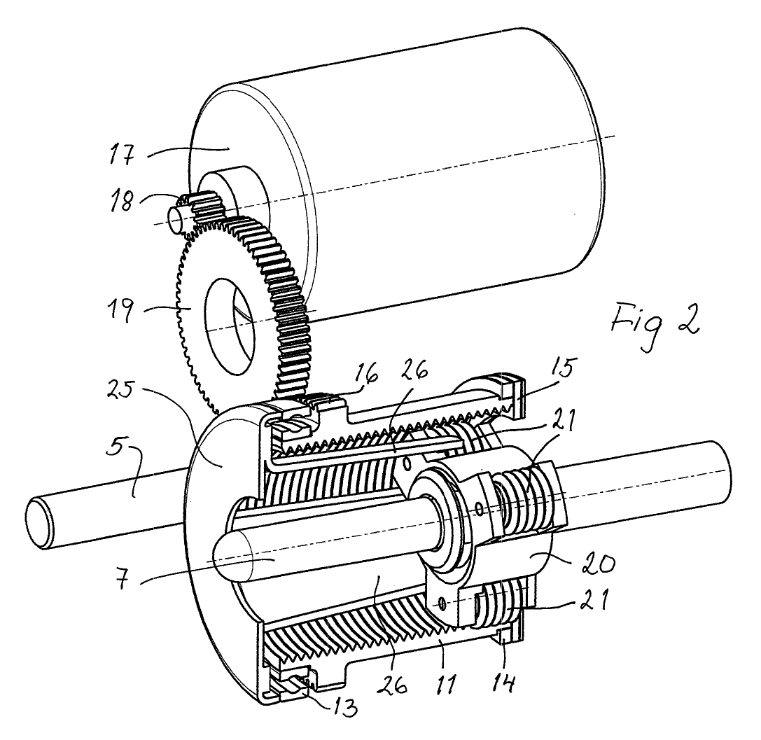

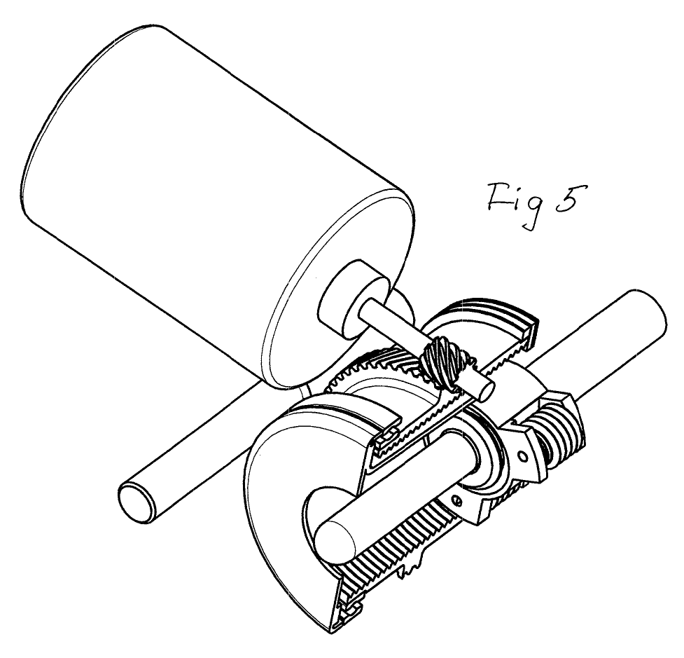

The purpose of FIG. 5, which is not provided with reference numerals for the sake of clarity, is to illustrate the use of a worm gear between the electric motor and the drive sleeve instead of the spur gear design illustrated in FIG. 2. With the use of a worm gear the axis of the electric motor may be perpendicular to that of the drive sleeve.

In a not illustrated modification a pre-tensioned compression spring could be arranged between the housing 10 and the thrust bearing 15 or between the drive sleeve 11 and the thrust bearing 15. This spring should be pre-tensioned to a value slightly lower than the force used for a normal parking brake application.

The function of the pre-tensioned spring is to allow for the brake disc to cool and shrink with remaining parking brake force provided by the spring.

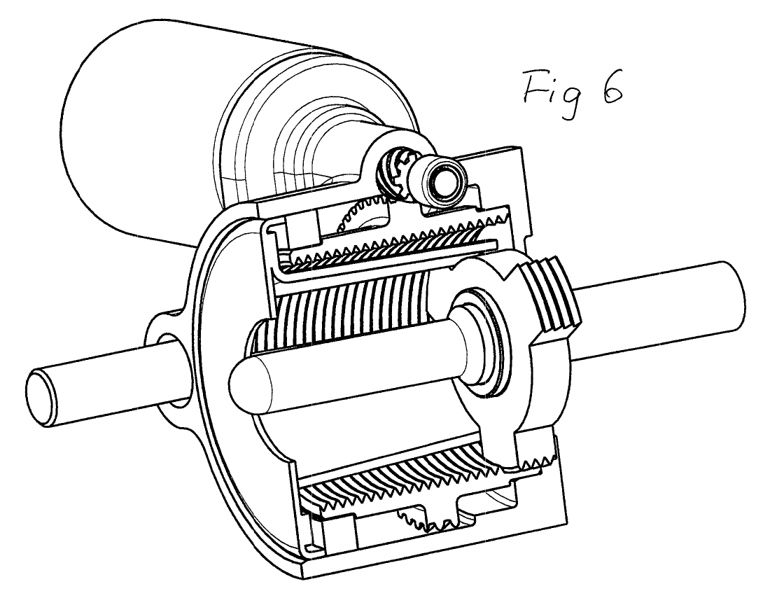

FIG. 6 illustrates a somewhat simplified version of the embodiment according to FIG. 5. In certain instances, a normal parking brake function is not required, but only a park-lock function, i e the brake is applied by the service brake actuator and may be locked in the applied condition by a so-called park-lock actuator. Accordingly, FIG. 6 shows such an actuator. The electric motor does not provide any power stroke in this case but only transfers the drive socket to the left in the Figure for its park-lock function and to the right for release. This means that a larger percentage of friction losses may be allowed, so that the rollers 21 of the previous embodiment may be omitted and be replaced by a conventional thread interaction.

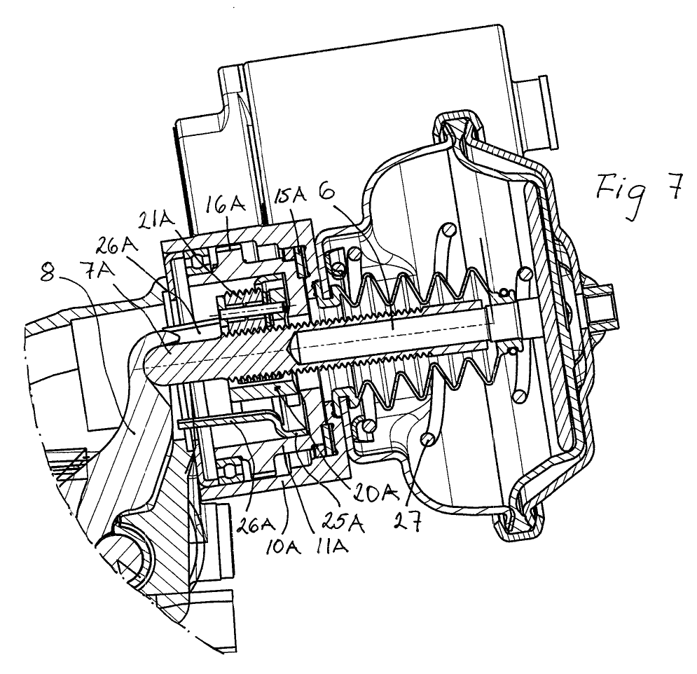

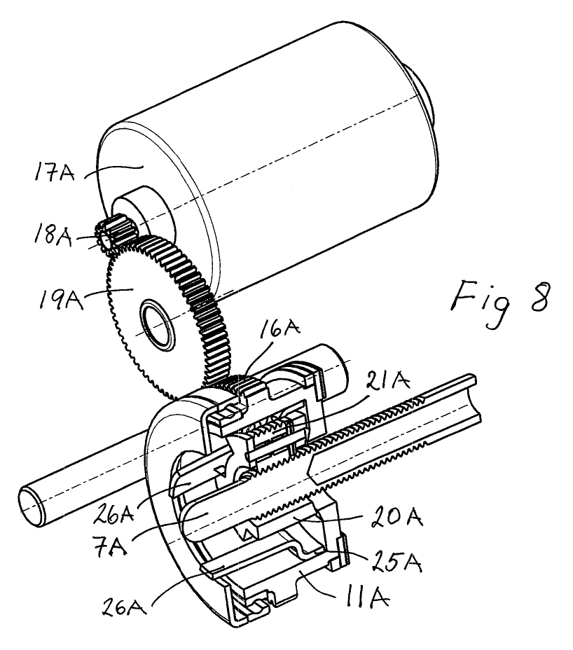

FIGS. 7 and 8 show a second embodiment of a parking brake actuator with similar functional characteristics as the one shown in FIGS. 1-5 but with a more compact design. As the actuator can be made with a shorter axial length, its installation space can be reduced, which may be of great advantage in vehicles, where the available space often is extremely limited. The same numerals are used for the different parts as in FIGS. 1-5 but with the addition of an “A”.

The following parts may thus be recognized (certain journalings being omitted): the piston rod 6, the push rod 7A, the lever 8, the housing 10A, the drive sleeve 11A, the thrust bearing 15A, the external gear 16A, the electric motor 17A, the motor transmission 18A, 19A, the drive socket 20A, the rollers 21A, the flange 25A, the fingers 26A, and the return spring 27.

The main difference in relation to the first embodiment according to FIGS. 1-5 is that the push rod 7A here is provided with external threads, with which the rollers 21A of the drive socket 20A cooperate. In order to assure the intended function, the push rod 7A may be prevented from rotation for example by a non-rotatable connection to the amplification lever 8.

If only a park-lock function is required, the rollers 21A may be replaced with a conventional thread interaction, like in FIG. 6.

As has appeared above and in the Figures, there are means in the two embodiments of the invention, shown for example in FIGS. 3 and 7, respectively, for transforming the rotational movement of the drive sleeve 11 and 11A, respectively, into an axial movement of the push rod 7 and 7A, respectively, through the participation of the drive socket 20 and 20A, respectively.

In the first embodiment, for example shown in FIG. 3, there is an engagement between the inner thread 12 in the drive sleeve 11 and the external grooves of the drive socket 20, which is held against rotation by means of the fingers 26 in the housing 10 and is brought into engagement with the flange 9 on the push rod 7.

In the second embodiment, for example shown in FIG. 7, the internal grooves of the drive socket 20A are in engagement with the external thread on the push rod 7A, and the drive socket 20A is rotated by the fingers 26A connected to the drive sleeve 11A.

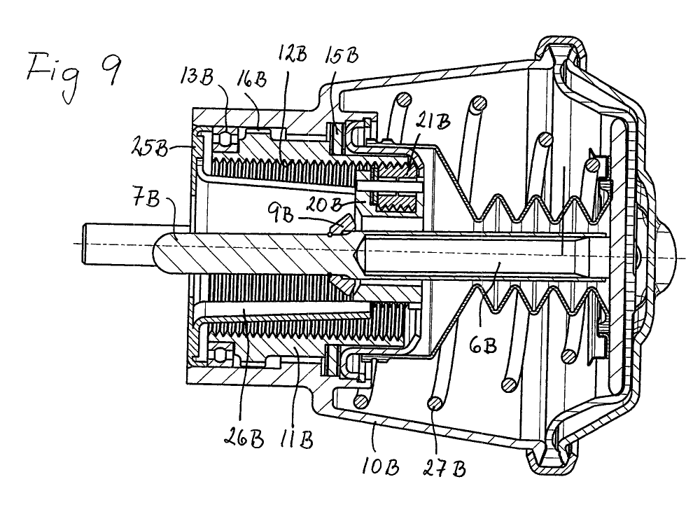

FIG. 9 shows a modification of the first embodiment shown in FIGS. 2-4, but most clearly in FIG. 3. Generally speaking, the modification is that the parking brake actuator is integrated into the service brake actuator to form an integrated unit. The main purpose of the modification is to further reduce the space requirement for the arrangement.

In FIG. 9, members corresponding to members in FIG. 3 have the same numerals with the addition of the letter “B”. The following members may thus be found in FIG. 9, even if they in some cases may have a somewhat different design in relation to the corresponding member in FIG. 3: the piston rod 6B, the push rod 7B, the flange 9B, the drive sleeve 11B, the internal thread 12B, the bearings 13B and 15B, the external gear 16B, the drive socket 20B, the rollers 21B, the insert 25B, the fingers 26B and the return spring 27B.

The numeral 10B designates a housing, which is common for the service brake actuator to the right in FIG. 9 and the parking brake actuator to the left.

A difference between the embodiment of FIG. 3 and its modification of FIG. 9 is also that the outer diameter of the piston rod 6B is smaller than the inner diameter of the push rod 7B along the majority of its length, so that there is a radial play between these two members during the parking brake stroke or application so as to enable relative radial movements during application at the engagement with the caliper lever 8, FIG. 3.

Due to the design as shown and described, the piston rod 6, 6B with the push rod 7, 7A, 7B can freely perform its arc-shaped application stroke at service braking. At parking braking the means for allowing the arc-shaped movement are either a small lateral movement of the diaphragm in the service brake actuator or the radial play between the piston rod 6B and the push rod 7B as shown in FIG. 9 and described above. The latter possibility is presently preferred for all embodiments.

1. A disc brake, comprising a disc brake caliper, which includes a brake application mechanism with an input element, and a service brake actuator providing a brake application force to the input element via a push rod characterized by an electromechanical brake actuator arranged between the caliper and the service brake actuator and applying its force at will on the push rod.

2. A disc brake according to claim 1, wherein the electromechanical actuator comprises an electric motor.

3. A disc brake according to claim 1, wherein the electromechanical actuator is used for parking brake application and/or for service brake application.

4. A disc brake according to claim 2, wherein the electromechanical actuator is used for park lock, an actuating retaining function only.

5. A disc brake according to claim 1, wherein the input element of the brake application mechanism is a pivotable amplification lever.

6. A disc brake according to claim 1, wherein means are provided for allowing the electromechanical actuator to cooperate with a push rod having an arc-shaped movement.

7. A disc brake according to claim 1, wherein the electromechanical brake actuator is mounted as a module between the disc brake caliper and the service brake actuator.

8. A disc brake according to claim 1, wherein the service brake actuator is pneumatically actuated.

9. A disc brake according to claim 1, wherein the electromechanical brake actuator comprises a drive sleeve journaled in a housing the actuator and an electric motor for rotation of the drive sleeve, a drive socket, through which the push rod extends, and means for transforming the rotational movement of the drive sleeve into an axial movement of the push rod through the participation of the drive socket.

10. A disc brake according to claim 9, wherein the push rod of the electromechanical brake actuator is slidably mounted as a prolongation of a piston rod of the service brake actuator.

11. A disc brake according to claim 9, wherein the drive socket has external grooves or an external thread for engagement with an internal thread in the drive sleeve, means being provided for preventing rotation of the drive socket, and wherein the push rod is provided with a flange with which the drive socket may engage.

12. A disc brake according to claim 11, wherein the drive socket has rotatable rollers provided with grooves.

13. A disc brake according to claim 11, wherein the drive socket has an external thread.

14. A disc brake according to claim 11, wherein the means for preventing rotation of the drive socket are fingers on an insert in the housing, the fingers extending in between the rollers.

15. A disc brake according to claim 9, wherein the drive socket has internal grooves or an internal thread for engagement with an external thread on the push rod, means being provided for rotatably connecting the drive socket with the drive sleeve.

16. A disc brake according to claim 15, wherein the drive socket has rotatable rollers provided with grooves.

17. A disc brake according to claim 15, wherein the drive socket has an internal thread.

18. A disc brake according to claim 15, wherein the means for rotatably connecting the drive socket with the drive sleeve are fingers on an insert in the drive sleeve, the fingers extending in between the rollers.

19. A disc brake according to claim 12, wherein a pre-tensioned compression spring is arranged between the housing and a thrust bearing for the drive sleeve or between the drive sleeve and the thrust bearing.

20. A disc brake according to claim 9, wherein the housing for the electromechanical brake actuator is integrated with the housing for the service brake actuator.

21. A disc brake according to claim 10, wherein the external diameter of the piston rod is smaller along the majority of its length than the inner diameter of the push rod.

22. An electromechanical brake actuator for use in a disc brake according to claim 1.
